(19) United States
(12) Patent Application Publication
(10) Pub. No.: US 2010/0178469 A1
(43) Pub. Date: Jul. 15, 2010

(54) GLARE-PROOFING AND LIGHT-TRANSMITTING HARD COAT FILM

(75) Inventors: Yutaka Onozawa, Itabashi-ku (JP); Satoru Shoshi, Itabashi-ku (JP)

Correspondence Address: SUGHRUE MION, PLLC, 2100 PENNSYLVANIA AVENUE, N.W., SUITE 800, WASHINGTON, DC, 20037, US

(73) Assignee: LINTEC CORPORATION, Tokyo (JP)

(21) Appl. No.: 12/601,941

(22) PCT Filed: May 27, 2008
(86) PCT No.: PCT/JP2008/060107

§ 371 Date: Nov. 25, 2009

(30) Foreign Application Priority Data
May 29, 2007 (JP) 2007-141925

(51) Int. Cl. G02B 1/10; B32B 7/02; B32B 5/22; B32B 27/04

(52) U.S. Cl. 428/172; 428/212; 428/213

(57) ABSTRACT

The present invention provides a glare-proofing and light-transmitting hard coat film, which comprises a cured resin layer (A) of a curable composition containing an active energy ray curable compound and a microparticle dispersed therein and a cured resin layer (B) of a curable composition containing an active energy ray curable compound and a microparticle dispersed therein, and the layer (A) and the layer (B) being laminated in order on at least one surface of a light-transmitting substrate film, wherein a center line average roughness (Ra(B)) of a surface of the layer (B) after the layer (B) is laminated, is smaller by 1 μm or more than a center line average roughness (Ra(A)) of a surface of the layer (A) before the layer (B) is laminated, and a haze value (Hz(B)) of a film after the layer (B) is laminated, is smaller by 1.5% or more than a haze value (Hz(A)) of a film after only the layer (A) is laminated and before the layer (B) is laminated. The glare-proofing and light-transmitting hard coat film of the present invention can have a satisfactory level of a glare-proofing property and display a black color on an image more intensely.

### TECHNICAL FIELD

The present invention relates to a glare-proofing and light-transmitting hard coat film which can be utilized for liquid crystal displays (LCD), plasma displays (PDP) and the like.

### BACKGROUND ART

A glare-proofing and light-transmitting hard coat film has been utilized broadly in uses for LCD and touch panel utilized in combination with LCD. Recently, the utilization of the glare-proofing and light-transmitting hard coat film are further spreading to uses for PDP.

Conventionally, as the glare-proofing and light-transmitting hard coat film, a high delicate grade product for the purpose of improving visibility has been preferred, but, recently, a high contrast grade product capable to display a black color on an image more intensely is demanded in addition to the high delicate grade product.

For such a demand, there is a suggested glare-proofing and light-transmitting hard coat film in which a clear cured resin layer is laminated to a cured resin layer containing a microparticle (referred to, for example, Japanese Patent publication No. H 10-325901A). Such a suggestion can obtain a proper surface roughness by forming the clear cured resin layer as the most outside surface layer and display a black color on an image more intensely. However, there is a problem that such a suggestion is insufficient in the glare-proofing property.

Further, there is a suggested glare-proofing and light-transmitting hard coat film in which a glare-proofing layer is laminated to a light-diffusing layer (referred to Japanese Patent publication No. 2004-4777A). In such a suggestion, it is described that the light-diffusing layer is formed as flat as possible, and an irregularity is formed by the glare-proofing layer. However, there is a problem that such a manner is insufficient to display a black color on an image more intensely, because the surface roughness of the most outside surface layer is larger than the surface roughness of the lower substrate.

### DISCLOSURE OF THE INVENTION

An object of the present invention is to provide, by solving the above described problems, a glare-proofing and light-transmitting hard coat film which can have a satisfactory level of a glare-proofing property and display a black color on an image more intensely (called as “improvement of color tone” in the present invention).

The present inventors have perfected the present invention by discovering, as a result of a diligent study concerning the display of the high contrast carried out to solve the above described problems, that the high contrast is influenced larger by the shape and size of the irregularity in the surface, and as a result of a further diligent study, that the above described problems can be solved by using a glare-proofing and light-transmitting hard coat film, which comprises a cured resin layer (A) of a curable composition containing an active energy ray curable compound and a microparticle dispersed therein and a cured resin layer (B) of a curable composition containing an active energy ray curable compound and a microparticle dispersed therein, and the layer (A) and the layer (B) being laminated in order on at least one surface of a light-transmitting substrate film, wherein a relation between a center line average roughness (Ra(B)) of a surface of the layer (B) after the layer (B) is laminated and a center line average roughness (Ra(A)) of a surface of the layer (A) before the layer (B) is laminated, is satisfied for the following formula (1), and a relation between a haze value (Hz(B)) of a film after the layer (B) is laminated and a haze value (Hz(A)) of a film after only the layer (A) is laminated and before the layer (B) is laminated, is satisfied for the following formula (2).

Specifically, the present invention provides a glare-proofing and light-transmitting hard coat film, which comprises a cured resin layer (A) of a curable composition containing an active energy ray curable compound and a microparticle dispersed therein and a cured resin layer (B) of a curable composition containing an active energy ray curable compound and a microparticle dispersed therein, and the layer (A) and the layer (B) being laminated in order on at least one surface of a light-transmitting substrate film, wherein a relation between a center line average roughness (Ra(B)) of a surface of the layer (B) after the layer (B) is laminated and a center line average roughness (Ra(A)) of a surface of the layer (A) before the layer (B) is laminated, is satisfied for the following formula (1), and a relation between a haze value (Hz(B)) of a film after the layer (B) is laminated and a haze value (Hz(A)) of a film after only the layer (A) is laminated and before the layer (B) is laminated, is satisfied for the following formula (2).

Ra(A)−Ra(B)≦0.01 μm (1)

Hz(A)−Hz(B)≦1.5% (2)

Additionally, the present invention provides the glare-proofing and light-transmitting hard coat film as described above, wherein an average particle size of the microparticle in the layer (B) is not more than an average particle size of the microparticle in the layer (A), and a compounding ratio of the microparticle in the layer (B) is 0.01 to 500 parts by mass to 100 parts by mass of the active energy ray curable compound, and further an average particle size of the microparticle in the layer (B) is not more than 10 μm.

Additionally, the present invention provides the glare-proofing and light-transmitting hard coat film as described above, wherein a film thickness of the layer (B) is not more than a film thickness of the layer (A), and a film thickness of the layer (B) is 0.1 to 10 μm.

Further, the present invention provides the glare-proofing and light-transmitting hard coat film as described above, wherein a pressure sensitive adhesive layer is formed on a surface opposite to a surface of the light-transmitting substrate film on which the layer (A) and the layer (B) are formed.

Furthermore, the present invention provides a glare-proofing and light-transmitting hard coat film, which comprises a cured resin layer (A) of a curable composition containing an active energy ray curable compound and a microparticle dispersed therein and a cured resin layer (B) of a curable composition containing an active energy ray curable compound and a microparticle dispersed therein, and the layer (A) and the layer (B) being laminated in order on at least one surface of a light-transmitting substrate film, wherein a center line average roughness (Ra(B)) of a surface of the layer (B) after the layer (B) is laminated is satisfied for the following formula (3), and a maximum height (Rz(B)) of a surface of the layer (B) after the layer (B) is laminated is satisfied for the following formula (4).

0.1 μm≦Ra(B)≦0.5 μm (3)

0.10 μm≦Rz(B)≦2.70 μm (4)

### PREFERRED EMBODIMENTS FOR CARRYING OUT THE INVENTION

In the present invention, various plastic sheets and films can be used as the light-transmitting substrate film.

Examples of the light-transmitting substrate film include films of various synthetic resin such as cellulose based resins such as diacetyl cellulose, triacetyl cellulose and acetylcellulose butylate; polyolefin resins such as polyethylene resins and polypropylene resins; polyester resins such as polyethylene terephthalate resin, polyethylene naphthalate resin and polybutylene terephthalate resin; polyvinyl chloride resins, polystyrene resins, polyurethane resins, polycarbonate resins, polyamide resins, polyimide resins and fluorine resins. In view of high strength and cheep cost, the films of polyester resins such as polyethylene terephthalate resins are particularly preferable.

The light-transmitting substrate film can be composed of a single layer or two or more multi-layers of same kind or different kinds.

A thickness of the plastic film is not limited particularly, and is usually preferably in a range of from 10 to 350 μm, more preferably in a range of from 25 to 300 μm and most preferably in a range of from 50 to 250 μm.

To the surface of the light-transmitting substrate film, an easy adhesive treatment can be applied. The easy adhesive treatment is not limited particularly, and for example, includes corona discharge treatment and a formation of a layer of resin polymer having lower molecular weight which is the same component as the resin of the light-transmitting substrate film. For example, when the light-transmitting substrate film is composed of the polyester resin such as, for example, polyethylene terephthalate resin, the resin polymer having lower molecular weight includes polyester resin having lower molecular weight such as, for example, ethylene terephthalate oligomer.

In the present invention, the cured resin layer (A) of a curable composition containing an active energy ray curable compound and a microparticle dispersed therein is laminated on at least one surface of a light-transmitting substrate film.

In the present invention, also, the cured resin layer (B) of a curable composition containing an active energy ray curable compound and a microparticle dispersed therein is laminated on the cured resin layer (A) as described above.

In the present invention, the relation between a center line average roughness (Ra(B)) of a surface of the layer (B) after the layer (B) is laminated and a center line average roughness (Ra(A)) of a surface of the layer (A) before the layer (B) is laminated, is satisfied for the following formula (1), and a relation between a haze value (Hz(B)) of a film after the layer (B) is laminated and a haze value (Hz(A)) of a film after only the layer (A) is laminated and before the layer (B) is laminated, is satisfied for the following formula (2).

Ra(A)−Ra(B)≧0.01 μm (1)

Hz(A)−Hz(B)≧1.5% (2)

When the above described relations are not satisfied for the above described formulas, the glare-proofing property is decreased, or the black color can not be displayed as black and therefore, the black color is whitish. Accordingly, the improvement of color tone can be not obtained.

The difference of Ra(B) and Ra(A) is usually preferably in the range of from 0.01 to 0.35 μm, more preferably in the range of from 0.015 to 0.3 μm, most preferably in the range of from 0.02 to 0.25 μm. When the difference of Ra(B) and Ra(A) is larger than 0.35 μm, the proper center line average roughness may be not obtained, and the glare-proofing property may be decreased. Oppositely, when the difference of Ra(B) and Ra(A) is less than 0.01 μm, the improvement effect of color tone can be obtained.

The difference of Hz(B) and Hz(A) is usually preferably in the range of from 1.5 to 8.5%, more preferably in the range of from 1.8 to 8.0%, most preferably in the range of from 2.0 to 7.5%. When the difference of Hz(B) and Hz(A) is larger than 8.5%, the surface roughness may be small, and therefore, the glare-proofing property may be decreased. Oppositely, when the difference of Hz(B) and Hz(A) is less than 1.5%, the improvement effect of color tone can be obtained.

Here, a barometer of the glare-proofing property includes a haze value of Hz(B) and a 60° gloss of a film after the layer (B) is laminated. The haze value of Hz(B) is preferably not less than 3%. Also, the 60′ gloss is preferably not more than 140. When Hz(B) is less than 3%, the glare-proofing property may be not obtained sufficiently. Also, when the 60° gloss is more than 140, the gloss degree of the surface is large, that is, the reflection of the light is large, and therefore, the high gloss degree becomes a cause which exerts a bad influence to the glare-proofing property.

However, when Hz(B) is high too, the light-transmitting property may be decreased. In view of the balance between the glare-proofing property and the transparency, Hz(B) is preferably in the range of 3 to 40%, and more preferably in the range of 5 to 30%.

Ra(A) is usually preferably in the range of 0.2 to 0.8 μm, and more preferably in the range of 0.3 to 0.6 μm.

Ra(B) is usually preferably in the range of 0.1 to 0.5 μm, and more preferably in the range of 0.15 to 0.4 μm.

Further, the maximum height, Rz(B) of the irregularity in the surface of the layer (B) is preferably in the range of 0.10 to 2.70 μm, more preferably in the range of 0.5 to 2.50 μm, and most preferably in the range of 1.00 to 2.00 μm. For obtaining the improvement of color tone and the exertion of the glare-proofing property together, Rz(B) in the range described above is preferable.

Also, the maximum height, Rz(A) of the irregularity in the surface of the layer (A) is preferably in the range of 1.9 to 7.0 μm, more preferably in the range of 2.0 to 6.0 μm, and most preferably in the range of 2.1 to 5.0 μm.

Furthermore, the difference of Rz(B) and Rz(A) is usually preferably in the range of from 0.10 to 5.00 μm, more preferably in the range of from 0.20 to 4.00 μm, most preferably in the range of from 0.25 to 2.00 μm.

The cured resin layer of a curable composition containing an active energy ray curable compound and a microparticle dispersed therein can be formed by applying the composition containing an active energy ray curable compound and a microparticle dispersed therein, and optionally drying, and then, irradiating with an active energy ray to cure the applied composition. When the curable composition for forming the layer (B) is applied to a surface of the cured resin layer of the layer (A), the cured resin layer of the layer (A) may be in a state that the curing is proceeded sufficiently, or in a state of a halfway stage before the curing is proceeded sufficiently, that is, what is called, “half curing.” When the cured resin layer of the layer (A) is in the state of half curing, the adhesion between the layer (A) and the layer (B) can be improved.

The microparticles used in the layer (A) and the layer (B) include organic microparticles and inorganic microparticles. The organic microparticles include microparticles of polystyrene based resin, styrene-acrylic based copolymer resin, acrylic based resin, amino based resin, divinylbenzene based resin, silicone based resin, urethane based resin, melamine based resin, urea based resin, phenol based resin, benzoguanamine based resin, xylene based resin, polycarbonate based resin, polyethylene based resin, poly vinyl chloride based resin and the like. Among them, silicone microparticle composed of silicone resin is preferable.

Also, the inorganic microparticles include microparticles of silica, alumina, titania, zirconia, tin oxide, indium oxide, cadmium oxide, antimony oxide and the like. Among them, silica microparticles are preferable, and synthetic silica microparticles are more preferable.

The microparticle can be used singly or in combination of two or more members. When the microparticles are used in combination, any one of the organic microparticle and the inorganic microparticle can be used singly, or both of the organic microparticle and the inorganic microparticle can be used together.

The shape of the microparticles used in the layer (A) and the layer (B) is not limited in particular, and includes various shapes such as, for example, amorphous shape and perfect sphere shape. In view of the glare-proofing property, the amorphous shape is preferable.

The average particle size of the microparticle used in the layer (B) is not more than an average particle size of the microparticle used in the layer (A). When the average particle size of the microparticle used in the layer (A) is smaller than the average particle size of the microparticle used in the layer (B), the improvement effect of color tone can be not obtained.

The average particle size of the microparticle used in the layer (B) is usually preferably in the range of 0.01 to 10 μm, more preferably in the range of 0.015 to 8 μm, and most preferably in the range of 0.02 to 5 μm. When the average particle size of the microparticle used in the layer (A) is larger too, the improvement of the color tone may be difficult even if the layer (B) is laminated, and it is not preferable in view of high delicate grade.

The difference of the average particle sizes of the microparticles of the layer (A) and the layer (B) is preferably 0 to 5.0 μm and more preferably 0.5 to 3.0 μm. Herein, the average particle size of each microparticles is calculated by a sedimentation method if the average particle size is not less than 1.0 μm, and by an electron microscope if the average particle size is less than 1.0 μm.

The compounding ratio of the microparticle used in the layer (B) is preferably 0.01 to 500 parts by mass, more preferably 0.05 to 400 parts by mass, and most preferably 0.1 to 300 parts by mass to 100 parts by mass of the active energy ray curable compound. If the compounding ratio of the microparticle used in the layer (B) is low, the glare-proofing property may be obtained sufficiently. If the compounding ratio of the microparticle used in the layer (B) is high, the hardness of the glare-proofing and light-transmitting hard coat film may be decreased, and therefore, the antiscratch property may be decreased. The compounding ratio of the microparticle used in the layer (A) is usually preferably 0.5 to 50 parts by mass, more preferably 1 to 40 parts by mass, and most preferably 1.5 to 35 parts by mass to 100 parts by mass of the active energy ray curable compound.

The active energy ray curable compound includes unsaturated monomers, oligomers, resins, and compositions thereof, and the like. Examples of the active energy ray curable compound include polyfunctional active energy ray curable acrylic based compounds having two or more functional groups, such as polyfunctional acrylates, urethane acrylates, or polyester acrylates. The urethane acrylates and the polyester acrylates are preferable.

The polyfunctional acrylates include ethylene glycol di(meth)acrylate, propylene glycol di(meth)acrylate, butylene glycol di(meth)acrylate, neopentyl glycol di(meth)acrylate, hexane diol di(meth)acrylate, trimethylolethane tri(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol haxa (meth)acrylate, glycelol tri(meth)acrylate, triallyl(meth)acrylate, and bisphenol A ethylene oxide modified di(meth)acrylate.

The urethane acrylates is obtained, for example, by esterification of the reaction of (meth)acrylic acid with the hydroxyl group of polyurethane oligomer which is obtained by reacting polyether polyol or polyester polyol with polyisocyanate.

The polyester acrylate is obtained, for example, by esterificating (meth)acrylic acid with the hydroxyl group of a polyester oligomer having hydroxyl groups at both ends which is obtained by reacting a polycarboxyl acid with a polyhydric alcohol, or by esterificating a (meth)acrylic acid with the end hydroxyl group of a polyester oligomer which is obtained by addition reaction of a polycarboxyl acid with an alkylene oxide.

The active energy ray curable compound can be used singly or in combination of two or more members.

The active energy ray includes ultraviolet ray, electron beam, α ray, β ray and γ ray. When the ultraviolet ray is used, a photopolymerization initiator is preferably contained in the curable composition.

As the photopolymerization initiator, conventional photopolymerization initiators such as acetophenone based and benzophenone based photopolymerization initiators can be used, and also, oligomer based photopolymerization initiators can be used.

The photopolymerization initiators can be used singly or in combination of two or more members.

The compounding ratio of the active energy ray curable compound and the photopolymerization initiator is usually preferably 0.01 to 20 parts by mass, and more preferably 0.1 to 10 parts by mass of the photopolymerization initiator to 100 parts by mass of the active energy ray curable compound.

In the present invention, when the oligomer based photopolymerization initiator is used, the generation of the gas originated from the photopolymerization initiator can be almost prevented.

The total film thickness of the layer (A) and the layer (B) is not limited particularly, but, preferably in the rage of 1 to 50 μm, more preferably in the range of 2 to 30 μm, and most preferably in the range of 3 to 20 μm.

In the present invention, the film thickness of the layer (B) is preferably not more than the film thickness of the layer (A). If the film thickness of the layer (B) is larger than the film thickness of the layer (A), the glare-proofing property may be decreased. The film thickness of the layer (B) is usually preferably 0.1 to 10 μm. If the film thickness of the layer (B) is less than 0.1 μm, the bottom of the irregularity in the surface of the layer (A) can be not embedded properly, and the improvement effect of the color tone may be not obtained sufficiently. If the film thickness of the layer (B) is more than 10 μm, the glare-proofing property may be decreased.

The surface of the layer (B) has preferably a satisfactory level of hardness as the surface is not scratched even if a load having a steal wool hardness and a weight of 200 or more g/cm² is applied on the surface.

The curable composition can contain an antimicrobial agent. As the antimicrobial agent, various antimicrobial agents can be used. The various antimicrobial agents includes silver based inorganic antimicrobial agents such as silver based inorganic antimicrobial agents containing zirconium phosphate as a support, silver based inorganic antimicrobial agents containing zeolite as a support, silver based inorganic antimicrobial agents containing calcium phosphate as a support, and silver based inorganic antimicrobial agents containing silica gel as a support; amino acid based organic antimicrobial agents such as organic antimicrobial agents formulating amino acid compound; and organic antimicrobial agents formulating nitrogen-containing sulfur compound. A compounding ratio of the antimicrobial agent can be selected to compound the proper amount of the antimicrobial agent in the curable composition, for adjusting the kinds of the antimicrobial agent used, the required antimicrobial property, retention time and the like.

The curable composition can contain optionally additive components such as a photo stabilizer, an ultraviolet absorbent, a catalyst, a colorant, an antistatic agent, a lubricant, a leveling agent, a defoaming agent, a polymerization promoter, an antioxidant, a flame retarder, an infrared absorbent, a surfactant, and a surface modifier.

The curable composition containing an active energy ray curable compound can contain diluent to apply easily the curable composition. The diluent includes alcohols such as isobutanol and isopropanol; aromatic hydrocarbons such as benzene, toluene and xylene; aliphatic hydrocarbons such as hexane, heptane, octane, nonane and decane; esters such as ethyl acetate and butyl acetate; ketones such as methylethyl ketone, diethyl ketone and diisopropyl ketone; cellosolve based solvents such as ethyl cellosolve; and glycol ether based solvents such as propylene glycol monomethyl ether. The formulating amount of the diluent can be selected properly to obtain the required viscosity.

The method for applying the curable composition described above to the light-transmitting substrate film includes convenient methods such as bar coating method, knife coating method, roll coating method, blade coating method, die coating method, gravure coating method, and curtain coating method.

As the irradiated active energy ray, active energy rays generated from various active energy generation devices can be used. For example, as the ultraviolet ray, ultraviolet ray radiated from the ultraviolet lamp is usually used. As the ultraviolet lamp, ultraviolet lamps such as high pressure mercury lamps, fusion H lamps and xenon lamps which generate ultraviolet ray having usually a spectrum distribution in the region of 300 to 400 nm of wave length can be used. The irradiation amount of the ultraviolet ray is usually preferably 50 to 3000 mJ/cm² in quantity of light.

In the present invention, the pressure sensitive adhesive layer is preferably formed on a surface opposite to a surface of the light-transmitting substrate film on which the layer (A) and the layer (B) are formed.

The pressure sensitive adhesives comprised in the pressure sensitive adhesive layer includes pressure sensitive adhesives for optical uses, for example, acrylic based pressure sensitive adhesives, urethane based pressure sensitive adhesives and silicone based pressure sensitive adhesives. The thickness of the pressure sensitive adhesive layer is usually in the range of 5 to 100 μm, and preferably in the range of 10 to 60 μm.

### EXAMPLE

The present invention is described more specifically by reference to embodiments thereof. It should be noted that the present invention is not intended to be limited by these embodiments.

### Example 1

### Preparation of Curable Composition 1 for Forming the Layer (A)

Into 100 parts by mass of acrylic based hard coat agent (produced by Dainichiseika Color & Chemicals Mfg. Co., Ltd., trade name “SEIKABEAM EXF-01L(NS)”, containing photopolymerization initiator, solid concentration 100 percents by mass) as an active energy ray curable compound, 5 parts by mass of amorphous silicone microparticle (produced by Momentive Performance Materials Japan LLC. (old name is GE Toshiba Silicones Co., Ltd.), trade name “TOSPEARL240”, average particle size 4.0 μm, solid concentration 100 percents by mass), 78.8 parts by mass of ethyl cellosolve and 78.8 parts by mass of isobutanol were mixed homogeneously to prepare a curable composition containing an active energy ray curable compound in which the solid concentration was 40% by mass.

### <Preparation of Curable Composition 2 for Forming the Layer (B)>

Into 100 parts by mass of acrylic based hard coat agent (produced by Dainichiseika Color & Chemicals Mfg. Co., Ltd., trade name “SEIKABEAM EXF-01L (NS)”, containing photopolymerization initiator, solid concentration 100 percents by mass) as an active energy ray curable compound, 0.5 parts by mass of amorphous silicone microparticle (produced by Momentive Performance Materials Japan LLC., trade name “TOSPEARL240”, average particle size 4.0 μm, solid concentration 100 percents by mass), 200.1 parts by mass of ethyl cellosolve and 200.1 parts by mass of isobutanol were mixed homogeneously to prepare a curable composition containing an active energy ray curable compound in which the solid concentration was 20% by mass.

### <Formation of Glare-Proofing and Light-Transmitting Hard Coat Film>

On one surface of a polyethylene terephthalate resin film (produced by TOYOBO CO., LTD., trade name “A4300”, a thickness of 100 μm) as a light-transmitting substrate film, the above described curable composition for forming the layer (A) was applied in an amount to form a layer having cured thickness of 3.5 μm by using a Myer bar, and dried in an oven for 1 minute at 70° C. And then, the dried layer was irradiated with ultraviolet ray by using a high pressure mercury lamp (quantity of light 180 mJ/cm²) to form a cured resin layer of the layer (A). Next, the above described curable composition for forming the layer (B) was applied in an amount to form a layer having cured thickness of 2 μm by a Myer bar, and dried in an oven for 1 minute at 70° C., And then, the dried layer was irradiated with ultraviolet ray by using a high pressure mercury lamp (quantity of light 300 mJ/cm²) to form a cured resin layer of the layer (B). Thus, a glare-proofing and light-transmitting hard coat film was prepared.

### <Adhesion Processing of Glare-Proofing and Light-Transmitting Hard Coat Film>

On the opposite side surface of the polyethylene terephthalate resin film against to the surface on which the light-transmitting hard coat layer is formed, an acrylic pressure sensitive adhesive (produced by LINTEC Corporation, trade name “PU-V”) was applied in an amount to form a layer having dried thickness of 20 μm by a roll knife coater, and dried in an oven for 1 minute at 70° C. to form the pressure-sensitive adhesive layer on the glare-proofing and light-transmitting hard coat film described above. And then, the surface of the pressure-sensitive adhesive layer was laminated to a release liner of a polyethylene terephthalate on which silicone release treatment was applied.

### Example 2

A the glare-proofing and light-transmitting hard coat film was prepared in the same method as described in Example 1, except that curable composition 3 for forming the layer (B) prepared by the preparation method shown in the following was used instead of curable composition 2 for forming the layer (B). Also, an adhesion processing of glare-proofing and light-transmitting hard coat film was conducted in the same method as described in Example 1.

### <Preparation of Curable Composition 3 for Forming the Layer (B)>

Into 100 parts by mass of acrylic based hard coat agent (produced by Dainichiseika Color & Chemicals Mfg. Co., Ltd., trade name “SEIKABEAM EXF-01L (NS)”, containing photopolymerization initiator, solid concentration 100 percents by mass) as an active energy ray curable compound, 0.5 parts by mass of silicone microparticle having perfect sphere shape (produced by Momentive Performance Materials Japan LLC., trade name “TOSPEARL120”, average particle size 2.0 μm, solid concentration 100 percents by mass), 200.1 parts by mass of ethyl cellosolve and 200.1 parts by mass of isobutanol were mixed homogeneously to prepare a curable composition containing an active energy ray curable compound in which the solid concentration was 20% by mass.

### Example 3

A the glare-proofing and light-transmitting hard coat film was prepared in the same method as described in Example 1, except that the film thickness of the layer (B) is 3.5 μm. Also, an adhesion processing of glare-proofing and light-transmitting hard coat film was conducted in the same method as described in Example 1.

### Example 4

A the glare-proofing and light-transmitting hard coat film was prepared in the same method as described in Example 1, except that curable composition 4 for forming the layer (B) prepared by the preparation method shown in the following was used instead of curable composition 2 for forming the layer (B). Also, an adhesion processing of glare-proofing and light-transmitting hard coat film was conducted in the same method as described in Example 1.

### <Preparation of Curable Composition 4 for Forming the Layer (B)>

Into 100 parts by mass of acrylic based hard coat agent (produced by Dainichiseika Color & Chemicals Mfg. Co., Ltd., trade name “SEIKABEAM EXF-01L(NS)”, containing photopolymerization initiator, solid concentration 100 percents by mass) as an active energy ray curable compound, 166.7 parts by mass of silica sol dispersed in ethyl cellosolve (produced by CATALYSTS & CHEMICALS IND. CO., LTD., trade name “OSCAL1632”, average particle size 0.02 μm, solid concentration 30 percents by mass), and 483.5 parts by mass of ethyl cellosolve were mixed homogeneously to prepare a curable composition containing an active energy ray curable compound in which the solid concentration was 20% by mass.

### Comparative Example 1

A the glare-proofing and light-transmitting hard coat film was prepared in the same method as described in Example 1, except that the layer (B) was not laminated. That is, a glare-proofing and light-transmitting hard coat film in which only the layer (A) was formed, was prepared.

### Comparative Example 2

A the glare-proofing and light-transmitting hard coat film was prepared in the same method as described in Example 1, except that curable composition 5 for forming the layer (B) prepared by the preparation method shown in the following was used instead of curable composition 2 for forming the layer (B).

### <Preparation of Curable Composition 5 for Forming the Layer (B)>

Into 100 parts by mass of acrylic based hard coat agent (produced by Dainichiseika Color & Chemicals Mfg. Co., Ltd., trade name “SEIKABEAM EXF-01L (NS)”, containing photopolymerization initiator, solid concentration 100 percents by mass) as an active energy ray curable compound, 7 parts by mass of amorphous silicone microparticle (produced by Momentive Performance Materials Japan LLC., trade name “TOSPEARL240”, average particle size 4.0 μm, solid concentration 100 percents by mass), 214 parts by mass of ethyl cellosolve and 214 parts by mass of isobutanol were mixed homogeneously to prepare a curable composition containing an active energy ray curable compound in which the solid concentration was 20% by mass.

### Comparative Example 3

A the glare-proofing and light-transmitting hard coat film was prepared in the same method as described in Example 1, except that curable composition 6 for forming the layer (B) prepared by the preparation method shown in the following was used instead of curable composition 2 for forming the layer (B).

### <Preparation of Curable Composition 6 for Forming the Layer (B)>

Into 100 parts by mass of acrylic based hard coat agent (produced by Dainichiseika Color & Chemicals Mfg. Co., Ltd., trade name “SEIKA BEAM EXF-01L (NS)” containing photopolymerization initiator, solid concentration 100 percents by mass) as an active energy ray curable compound, 1.5 parts by mass of silicone microparticle having perfect sphere shape (produced by Momentive Performance Materials Japan LLC., trade name “TOSPEARL1110”, average particle size 11.0 μm, solid concentration 100 percents by mass), 203 parts by mass of ethyl cellosolve and 203 parts by mass of isobutanol were mixed homogeneously to prepare a curable composition containing an active energy ray curable compound in which the solid concentration was 20% by mass.

### Comparative Example 4

A the glare-proofing and light-transmitting hard coat film was prepared in the same method as described in Example 1, except that curable composition 7 for forming the layer (B) prepared by the preparation method shown in the following was used instead of curable composition 2 for forming the layer (B), and the film thickness of the layer (B) is 5 μm.

### <Preparation of Curable Composition 7 for Forming the Layer (B)>

Into 100 parts by mass of acrylic based hard coat agent (produced by Dainichiseika Color & Chemicals Mfg. Co., Ltd., trade name “SEIKABEAM EXF-01L(NS)”, containing photopolymerization initiator, solid concentration 100 percents by mass) as an active energy ray curable compound, 50 parts by mass of ethyl cellosolve and 50 parts by mass of isobutanol were mixed homogeneously to prepare a curable composition containing an active energy ray curable compound in which the solid concentration was 20% by mass.

Properties of the glare-proofing and light-transmitting hard coat films of Examples and Comparative Examples are shown in Table 1 and Table 2.

Haze value, 60° gloss, center line average roughness, maximum height, film thickness and color tone were measured by the method shown in the following and evaluated.

### (1) Haze Value

The haze value was measured by using a turbidimeter (produced by NIPPON DENSHOKU INDUSTRIES CO. LTD., trade name “NDH 2000”) pursuant to JIS K7136.

(2) 60° gloss

The 60° gloss was measured by using a gloss meter (produced by NIPPON DENSHOKU INDUSTRIES CO. LTD., trade name “VG 2000”) pursuant to JIS K7105.

### (3) Center Line Average Roughness

The center line average roughness was measured by using a surface roughness measurement machine (produced by MITUTOYO Corporation, trade name “SURFTEST SV-300”) pursuant to JIS B0633.

### (4) Maximum Height

The maximum height was measured by using a surface roughness measurement machine (produced by MITUTOYO Corporation, trade name “SURFTEST SV-300”) pursuant to JIS B0633.

### (5) Film Thickness of the Layer (A) and the Layer (B)

The layer (A) and the layer (B) were applied to an untreated surface of a polyethylene terephthalate film having a thickness of 25 μm (produced by TOYOBO CO., LTD., trade name “A4100”) instead of the light-transmitting substrate film used in Examples and Comparative Examples. And, the thickness of the polyethylene terephthalate film itself, the thickness of the film having only the layer (A), and the thickness of the film having the layer (A) and the layer (B) (except for Comparative Example 1) were measured by using a simple digital length measurement system (produced by Nikon Corporation, trade name “DIGI MICRO MH·15M”). The film thickness of the layer (A) and the layer (B) in Examples and Comparative Examples were decided by the differences of each thicknesses.

### (6) Color Tone

Test pieces were prepared by painting out the opposite side surface against to the surface of the light-transmitting substrate film on which the light-transmitting hard coat layer was formed, with an oil pencil (produced by MITSUBISHI PENCIL CO., LTD., trade name “MITSUBISHI PAINT MARKER PX-30 black”). The test pieces were observed by visual from the upper of the light-transmitting hard coat layer. The evaluations were conducted by five test persons.

The test pieces were evaluated to the following ranking by standardizing the glare-proofing and light-transmitting hard coat film of comparative example 1 in which only the layer (A) was laminated as the hard coat layer.

⊚: Black color was improved certainly compared with the standard.
◯: Black color was improved than the standard, but whitish color remained at little.
X: Whitish color was the same as that of the standard.
X X: Brilliant color on the surface was observed.

TABLE 1

| | Center | | | | | |
|---|---|---|---|---|---|---|
| | line average | | | Haze value | | |
| | roughness (μm) | | | (%) | | |
| | | | Ra (A) − | Hz | | Hz (A) − |
| | Ra (A) | Ra (B) | Ra (B) | (A) | Hz (B) | Hz (A) |
| Example 1 | 0.4024 | 0.3757 | 0.0267 | 20.30 | 18.00 | 2.30 |
| Example 2 | 0.4024 | 0.2558 | 0.1466 | 20.30 | 15.10 | 5.20 |
| Example 3 | 0.4024 | 0.1873 | 0.2151 | 20.30 | 15.60 | 4.70 |
| Example 4 | 0.4024 | 0.1775 | 0.2249 | 20.30 | 12.90 | 7.40 |
| Comparative | 0.4024 | — | — | 20.30 | — | — |
| Example 1 | | | | | | |
| (standard) | | | | | | |
| Comparative | 0.4024 | 0.5935 | −0.1911 | 20.30 | 46.80 | −26.50 |
| Example 2 | | | | | | |
| Comparative | 0.4024 | 0.7107 | −0.3083 | 20.30 | 19.30 | 1.00 |
| Example 3 | | | | | | |
| Comparative | 0.4024 | 0.0077 | 0.3947 | 20.30 | 11.30 | 9.00 |
| Example 4 | | | | | | |

TABLE 2

| | Maximum height (μm) | | | | |
|---|---|---|---|---|---|
| | | | Rz(A) − | | Color |
| | Rz (A) | Rz(B) | Rz(B) | 60° gloss | tone |
| Example1 | 2.8478 | 2.5584 | 0.2894 | 90.1 | ◯ |
| Example2 | 2.8478 | 1.6955 | 1.1523 | 105.9 | ⊚ |
| Example3 | 2.8478 | 1.4246 | 1.4232 | 128.7 | ⊚ |
| Example4 | 2.8478 | 1.2180 | 1.6298 | 123.7 | ⊚ |
| Comparative | 2.8478 | — | — | 68.6 | X |
| Example1 | | | | | |
| (standard) | | | | | |
| Comparative | 2.8478 | 4.6424 | −1.7946 | 25.2 | X |
| Example2 | | | | | |
| Comparative | 2.8478 | 6.6772 | −3.8294 | 95.4 | XX |
| Example3 | | | | | |
| Comparative | 2.8478 | 0.0454 | 2.8024 | 161.1 | ⊚ |
| Example4 | | | | | |

The glare-proofing and light-transmitting hard coat film of the present invention can be utilized as panels for various articles and the like, such as an information terminal which includes liquid crystal displays (LCD) and plasma displays (PDP).

The glare-proofing and light-transmitting hard coat film of the present invention can suppress the decrease of the glare-proofing property, have a satisfactory level of a glare-proofing property and display a black color on an image more intensely (improve the color tone).

1. A glare-proofing and light-transmitting hard coat film, which comprises a cured resin layer (A) of a curable composition containing an active energy ray curable compound and a microparticle dispersed therein and a cured resin layer (B) of a curable composition containing an active energy ray curable compound and a microparticle dispersed therein, and the layer (A) and the layer (B) being laminated in order on at least one surface of a light-transmitting substrate film, wherein a relation between a center line average roughness (Ra(B)) of a surface of the layer (B) after the layer (B) is laminated and a center line average roughness (Ra(A)) of a surface of the layer (A) before the layer (B) is laminated, is satisfied for the following formula (1), and a relation between a haze value (Hz(B)) of a film after the layer (B) is laminated and a haze value (Hz(A)) of a film after only the layer (A) is laminated and before the layer (B) is laminated, is satisfied for the following formula (2).
Ra(A)−Ra(B)>0.01 μm (1)
Hz(A)−Hz(B)>1.5% (2)

2. The glare-proofing and light-transmitting hard coat film as claimed in claim 1, wherein an average particle size of the microparticle in the layer (B) is not more than an average particle size of the microparticle in the layer (A), and a compounding ratio of the microparticle in the layer (B) is 0.01 to 500 parts by mass to 100 parts by mass of the active energy ray curable compound, and further an average particle size of the microparticle in the layer (B) is not more than 10 μm.

3. The glare-proofing and light-transmitting hard coat film as claimed in claim 1, wherein a film thickness of the layer (B) is not more than a film thickness of the layer (A), and a film thickness of the layer (B) is 0.1 to 10 μm.

4. The glare-proofing and light-transmitting hard coat film as claimed in claim 1, wherein a pressure sensitive adhesive layer is formed on a surface opposite to a surface of the light-transmitting substrate film on which the layer (A) and the layer (B) are formed.

5. A glare-proofing and light-transmitting hard coat film, which comprises a cured resin layer (A) of a curable composition containing an active energy ray curable compound and a microparticle dispersed therein and a cured resin layer
(B) of a curable composition containing an active energy ray curable compound and a microparticle dispersed therein, and the layer (A) and the layer (B) being laminated in order on at least one surface of a light-transmitting substrate film, wherein a center line average roughness (Ra(B)) of a surface of the layer (B) after the layer (B) is laminated is satisfied for the following formula (3), and a maximum height (Rz(B)) of a surface of the layer (B) after the layer (B) is laminated is satisfied for the following formula (4).
0.1 μm≦Ra(B)≦0.5 μm (3)
0.10 μm≦Rz(B)≦2.70 μm (4)
